(19) United States
(12) Patent Application Publication
(10) Pub. No.: US 2026/0058379 A1
(43) Pub. Date: Feb. 26, 2026

(54) BUSBAR TERMINAL JOINING STRUCTURE

(71) Applicant: SANDEN CORPORATION, Gunma (JP)

(72) Inventor: Toru TANAKA, Gunma (JP)

(21) Appl. No.: 19/103,263

(22) PCT Filed: Jul. 27, 2023
(86) PCT No.: PCT/JP2023/027535

§ 371 Date: Feb. 12, 2025

(30) Foreign Application Priority Data
Aug. 24, 2022 (JP) 2022-133541

(51) Int. Cl. H01R 4/02; H01R 43/02

(52) U.S. Cl. CPC H01R 4/027; H01R 43/0263; H01R 43/0221

(57) ABSTRACT

When a busbar and an electronic device terminal are joined by welding, a good joint state is obtained while a positional relationship between the joint portion of the busbar and the terminal is stably maintained. A busbar terminal joining structure includes a welding target portion having a joint surface to be joined to a tip end portion of a rod-shaped terminal by welding, and a terminal holding portion provided at a position apart from the welding target portion and configured to limit movement of the terminal in the welding target portion when a base end portion of the terminal is inserted thereinto.

### TECHNICAL FIELD

The present invention relates to a busbar terminal joining structure.

### BACKGROUND ART

A busbar is a conductive member for power supply, and is particularly used as wiring for flowing great current. In the field of in-vehicle electronics, a power control unit (PCU) on which a large number of power semiconductor devices such as an insulated gate bipolar transistor (IGBT) are mounted is used, and busbars are used for connection between control boards of the PCU and connection between the control boards and electronic devices (drive device, heat generation device, and the like).

When soldering is used for joining a busbar and a terminal of an electronic device, cracks are caused at the joint portion, which leads to a defect such as reduction in mechanical strength. For this reason, joining by welding using a heating source having a high energy density, such as laser light or plasma, is adopted (see, for example, Patent Literature 1 below).

### CITATION LIST

### Patent Literature

Patent Literature 1: JP-A-2006-179197

### SUMMARY OF INVENTION

### Problems to be Solved by Invention

In order to avoid failure in joining, in a case where a busbar and an electronic device terminal are joined by welding, it is important to stably maintain a positional relationship between the joint portion of the busbar and the terminal.

For example, in joining of a rod-shaped terminal and a busbar, the joint portion of the busbar is generally machined into a substantially U-shape so as to surround the rod-shaped terminal. At this time, when welding is performed in a state in which the rod-shaped terminal is inserted into the substantially U-shaped joint portion, a clearance between the joint portion of the busbar and the rod-shaped terminal is expanded by heating at the time of welding, and welding may be performed in a state in which the rod-shaped terminal is located at a biased position due to the expanded clearance. In such a case, there is a problem that there is a deviation in the thickness of a melted portion around the rod-shaped terminal and welding accuracy is not stabilized.

An object of the present invention is to cope with such a problem. That is, the object of the present invention is to obtain, when a busbar and an electronic device terminal are joined by welding, a good joint state while stably maintaining a positional relationship between the joint portion of the busbar and the terminal.

### Solution to Problems

In order to solve the above-described problems, the present invention provides a busbar terminal joining structure having the following configuration.

A busbar terminal joining structure for joining a busbar and a terminal of an electronic device by welding includes a welding target portion having a joint surface to be joined to a tip end portion of the terminal having a rod shape by welding, and a terminal holding portion provided at a position apart from the welding target portion and configured to limit movement of the terminal in the welding target portion when a base end portion of the terminal is inserted thereinto.

### Effects of Invention

According to the present invention having such a feature, when the busbar and the electronic device terminal are joined by welding, a good joint state can be obtained while the positional relationship between the joint portion of the busbar and the terminal is stably maintained.

### BRIEF DESCRIPTION OF DRAWINGS

FIG. 1 is an explanatory view (perspective view) illustrating a busbar terminal joining structure according to an embodiment of the present invention.

FIG. 2 is an explanatory view (side view) illustrating the busbar terminal joining structure according to the embodiment of the present invention.

FIG. 3 is an explanatory view (sectional view taken along A-A line) illustrating the busbar terminal joining structure according to the embodiment of the present invention

FIG. 4 is an explanatory view (sectional view taken along B-B line) illustrating the busbar terminal joining structure according to the embodiment of the present invention.

FIG. 5 is an explanatory view (sectional view taken along C-C line) illustrating the busbar terminal joining structure according to the embodiment of the present invention.

FIG. 6 is an explanatory view of a heating device including the busbar terminal joining structure according to the embodiment of the present invention.

### DESCRIPTION OF EMBODIMENTS

Hereinafter, an embodiment of the present invention will be described with reference to the drawings. In the following description, the same reference numerals in different drawings indicate parts having the same functions, and redundant description in the respective drawings is appropriately omitted.

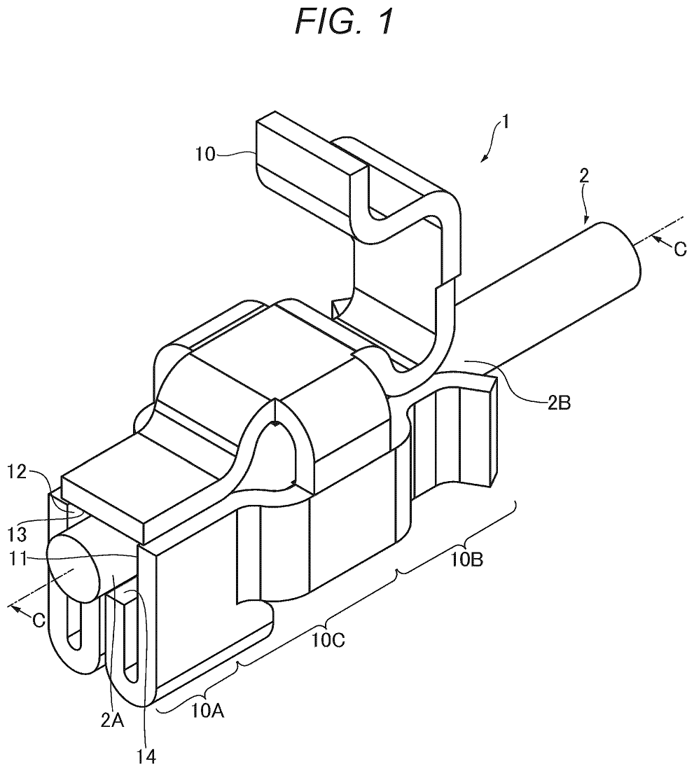

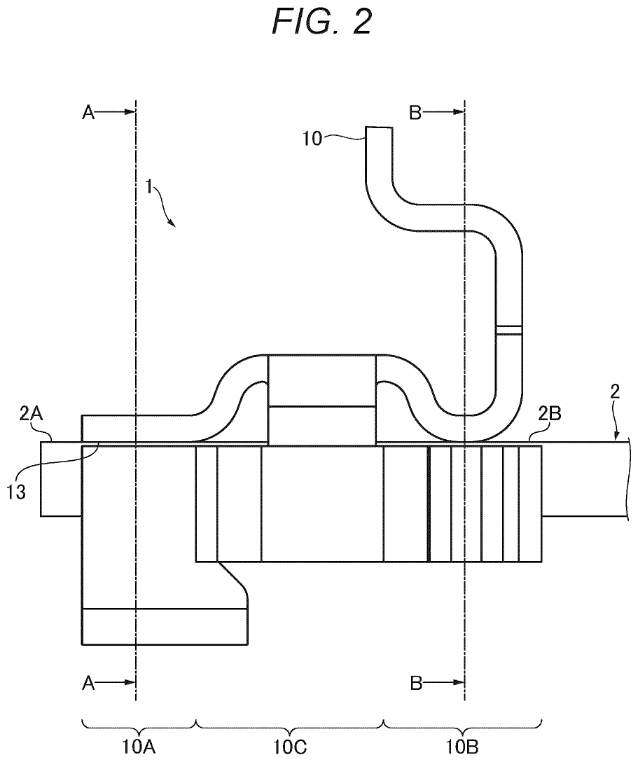

FIGS. 1 to 5 illustrate an example of a terminal joining structure 1 in which a rod-like (round rod-like in the illustrated example) terminal 2 of an electronic device (not illustrated) is joined to a busbar 10 by welding. The busbar 10 includes, as the terminal joining structure 1, a welding target portion 10A, a terminal holding portion 10B, and a coupling portion 10C coupling the welding target portion 10A and the terminal holding portion 10B.

The welding target portion 10A of the busbar 10 has a joint surface (first joint surface 11, second joint surface 12, and third joint surface 13) to be joined to a tip end portion 2A of the terminal 2 by welding. The welding target portion 10A is a portion at which the terminal 2 and the busbar 10 are melted and joined by heating with laser beam irradiation or the like.

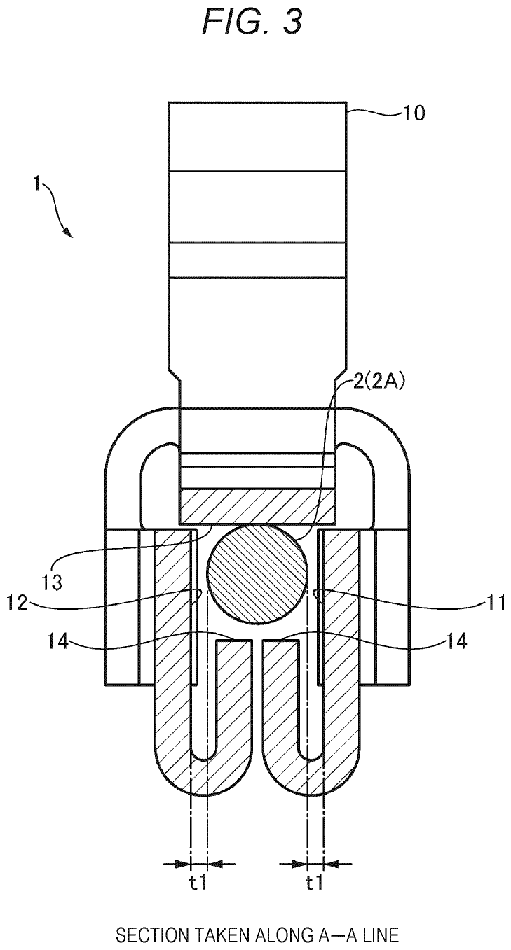

As illustrated in FIG. 3, the welding target portion 10A has the first joint surface 11 and the second joint surface 12 arranged in pair with the side surface of the tip end portion 2A of the terminal 2 interposed therebetween. In the illustrated example, the third joint surface 13 facing the side surface of the terminal 2 in a direction different from those of the first joint surface 11 and the second joint surface 12 is provided. Further, the welding target portion 10A has a guide portion 14 that guides the side surface of the terminal 2 at an end portion obtained by folding back each of the first joint surface 11 and the second joint surface 12.

In the welding target portion 10A, the tip end portion 2A of the terminal 2 is disposed in a space sandwiched between the first joint surface 11 and the second joint surface 12, and is disposed in a space sandwiched between the third joint surface 13 and the guide portions 14. At the time of joining by welding, it is important to dispose the tip end portion 2A of the terminal 2 without the tip end portion 2A biased in the space sandwiched between the first joint surface 11 and the second joint surface 12 and the space sandwiched between the third joint surface 13 and the guide portions 14 in order to stabilize welding accuracy.

At this time, the guide portions 14 reduce insertion of the tip end portion 2A of the terminal 2 obliquely into the welding target portion 10A. With the guide portions 14, the posture of the terminal 2 in the welding target portion 10A can be controlled substantially parallel to the third joint surface 13.

On the other hand, the terminal holding portion 10B of the busbar 10 is provided at a located apart from the welding target portion 10A described above, and limits movement of the terminal 2 in the welding target portion 10A by inserting a base end portion 2B of the terminal 2 therein.

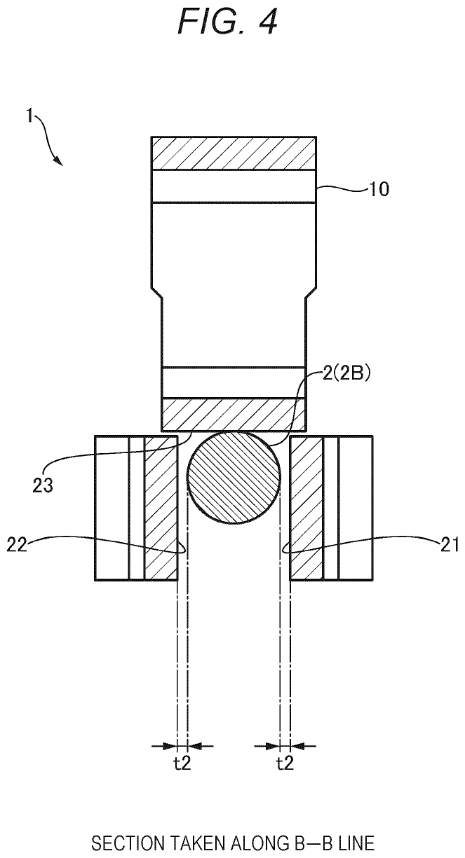

More specifically, as illustrated in FIG. 4, the terminal holding portion 10B bas a pair of control surfaces (first control surface 21 and second control surface 22) facing each other. In addition, the terminal holding portion 10B has a third control surface 23 that controls the position of the terminal 2 from a direction different from those of the first control surface 21 and the second control surface 22.

A clearance with the terminal 2 in the terminal holding portion 10B is narrower than a clearance with the terminal 2 in the welding target portion 10A. In the illustrated example, as illustrated in FIG. 3, in the terminal holding portion 10A, there is a clearance having a gap width tl between the terminal 2 disposed between the first joint surface 11 and the second joint surface 12 and the first joint surface 11 or the second joint surface 12, and as illustrated in FIG. 4, in the terminal holding portion 10B, there is a clearance having a gap width t2 between the terminal 2 disposed between the first control surface 21 and the second control surface 22 and the first control surface 21 or the second control surface 22, but here, a relationship of t2<t1 is established.

Since the terminal holding portion 10B is apart from the welding target portion 10A through the coupling portion 10C, the terminal holding portion 10B is less susceptible to heat at the time of welding. Thus, even if the above-described clearance in the welding target portion 10A is expanded at the time of welding, the terminal holding portion 10B which is less susceptible to heat at the time of welding controls and holds the position of the terminal 2, so that the movement of the terminal 2 in the welding target portion 10A is limited. As a result, it is possible to stably maintain the positional relationship between the joint portion (welding target portion 10A) of the busbar 10 and the terminal 2 at the time of welding and to obtain a favorable joint state.

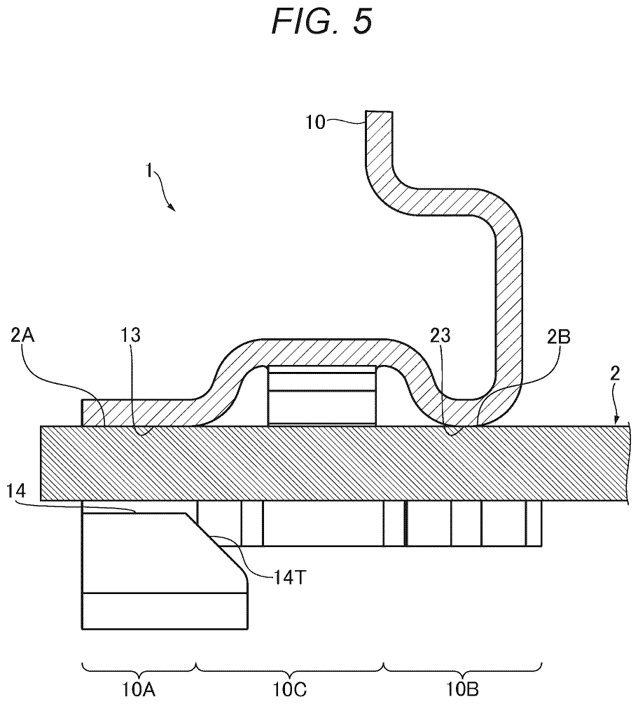

As illustrated in FIG. 5, the guide portion 14 provided in the welding target portion 10A is provided with a tapered guide portion 14T that separates from the third joint surface 13 described above while extending toward the terminal holding portion 10B. The tapered guide portion 14T is provided continuously from an end portion of the guide portion 14 parallel to the third joint surface 13, and has a function of implementing smooth insertion when the tip end portion 2A of the terminal 2 is inserted into the above-described space in the welding target portion 10A.

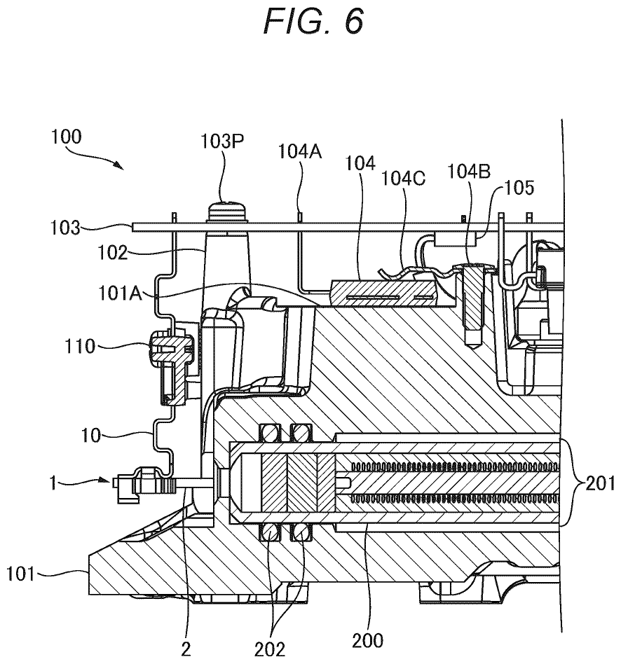

As illustrated in FIG. 6, the terminal joining structure 1 described above can be adopted when the busbar 10 is joined to the terminal 2 of a heater 200. FIG. 6 illustrates a heating device 100 adopting the terminal joining structure 1. The heating device 100 heats a heat medium flowing through a channel 201, which is formed in a housing 101, with the heater 200 disposed in the channel 201. A heat-resistant seal member 202 is disposed around the heater 200 disposed in the housing 101 in order to block the heat medium from the channel 201.

In the heating device 100, the other end of the busbar 10 of which one end is joined to the terminal 2 of the heater 200 is connected to a control board 103, on which a temperature sensor 105 and the like are mounted, through a relay component 110. That is, the busbar 10 is used as power supply wiring between the control board 103 and the heater 200. The control board 103 is fixed and supported at an end portion of a support projection 102 of the housing 101 with a fixing screw 103P.

A circuit component 104 such as an IGBT unit is mounted on a mount surface 101A of the housing 100 of the heating device 100. A circuit component terminal 104A of the circuit component 104 is connected to the control board 103. Here, the mount surface 101A is disposed apart from the installation location of the heater 200 to thermally protect the circuit component 104. The circuit component 104 is pressed and supported on the mount surface 101A with a fixture 104 of which one end is fixed to the housing 101 with a fixing screw 104.

In a case where the terminal joining structure 1 described above is adopted in such a heating device 100, when the busbar 10 and the terminal 2 of the heater 200 are joined by welding, a good joint state can be obtained while the positional relationship between the joint portion of the busbar 10 and the terminal 2 is stably maintained. As a result, the heating device 100 can be operated stably.

As described above, according to the terminal joining structure 1 for the busbar 10 according to the embodiment of the present invention, the terminal holding portion 10B is provided at the position apart from the welding target portion 10A at the joint portion of the busbar 10, so that the position of the terminal 2 in the welding target portion 10A is held by the terminal holding portion 10B even in a state in which the terminal 2 and the busbar 10 are melted in the welding target portion 10A at the time of welding. As a result, stable welding can be performed, and welding accuracy in terminal joining can be enhanced.

Since the guide portions 14 are provided in the welding target portion 10A, it is possible to reduce the insertion of the tip end portion 2A of the terminal 2 obliquely into the welding target portion 10A. In addition, the guide portions 14 can control the posture of the terminal 2 substantially parallel to the third joint surface 13 in the welding target portion 10A. Furthermore, since the tapered guide portion 14T is provided at the guide portion 14, the terminal 2 can be smoothly inserted into the space in the welding target portion 10A.

Although the embodiments of the present invention have been described in detail above with reference to the drawings, the specific configuration is not limited to these embodiments, and modifications and the like of the design without departing from the gist of the present invention are also included in the present invention. Furthermore, each of the above-described embodiments can be combined by diverting their techniques as long as there is no particular contradiction or problem in the purpose, configuration, and the like.

### LIST OF REFERENCE SIGNS

1 Terminal Joining Structure
2 Terminal
2A Tip End Portion
2B Base End Portion
10 Busbar
10A Welding Target Portion
10B Terminal Holding Portion
10C Coupling Portion
11 First Joint Surface
12 Second Joint Surface
13 Third Joint Surface
14 Guide Portion
14T Tapered Guide Portion
21 First Control Surface
22 Second Control Surface
23 Third Control Surface
100 Heating Device
101 Housing
101A Mount Surface
102 Support Projection
103 Control Board
103P Fixing Screw
104 Circuit Component (IGBT Unit)
104A Circuit Component Terminal
104B Fixing Screw
104C Fixture
105 Temperature Sensor
110 Relay Component
200 Heater
201 Channel
202 Seal Member

1. A busbar terminal joining structure for joining a busbar and a terminal of an electronic device by welding, comprising:
a welding target portion having a joint surface to be joined to a tip end portion of the terminal having a rod shape by welding; and
a terminal holding portion provided at a position apart from the welding target portion and configured to limit movement of the terminal in the welding target portion when a base end portion of the terminal is inserted thereinto.

2. The busbar terminal joining structure according to claim 1, wherein a clearance with the terminal in the terminal holding portion is narrower than a clearance with the terminal in the welding target portion.

3. The busbar terminal joining structure according to claim 1, wherein the welding target portion has first and second joint surfaces arranged in pair with a side surface of the terminal interposed therebetween, and a third joint surface facing the side surface of the terminal in a direction different from those of the first and second joint surfaces.

4. The busbar terminal joining structure according to claim 3, wherein the welding target portion has a guide portion that guides the side surface of the terminal at an end portion obtained by folding back each of the first and second joint surfaces.

5. The busbar terminal joining structure according to claim 4, wherein the guide portion has a tapered guide portion that separates from the third joint surface while extending toward the terminal holding portion.

6. A heating device comprising: the busbar terminal joining structure according to claim 1, wherein the terminal is a heater terminal.
